(19) United States
(12) Patent Application Publication
(10) Pub. No.: US 2022/0217037 A1
(43) Pub. Date: Jul. 7, 2022

(54) DETECTING RELATIONSHIPS BETWEEN WEB SERVICES IN A WEB-BASED COMPUTING SYSTEM

(71) Applicant: NAMOGOO TECHNOLOGIES LTD., Herzeliya (IL)

(72) Inventors: Ohad Moti Greenshpan, Herzeliya (IL); Chemi Menachem Katz, Herzeliya (IL); Orr Siloni, Herzeliya (IL); Roman Lvovsky, Herzeliya (IL)

(21) Appl. No.: 17/610,610

(22) PCT Filed: Jun. 24, 2020
(86) PCT No.: PCT/IB2020/000501

§ 371 Date: Nov. 11, 2021

Related U.S. Application Data
(60) Provisional application No. 62/865,726, filed on Jun. 24, 2019.

(51) Int. Cl. H04L 41/0266; H04L 41/0253; G06F 8/36

(52) U.S. Cl. CPC H04L 41/0266; G06F 8/36; H04L 41/0253

(57) ABSTRACT

Systems and methods are disclosed for detecting relationships between web services in a web-based computing system. The systems and methods collects, via a set of functions of a web browser of a user device accessing a target web asset, data associated with a set of web services added by the target web asset. Based on the data, a set of relationships are determined between the target web asset, a first web service of the set of web services, and a second web service of the set of web services. A log is generated including information identifying the target web asset, the first web service, the second web service, and the set of relationships.

### TECHNICAL FIELD

Aspects and implementations of the present disclosure relate to web application management, and more specifically, to detecting relationships between web services in a web-based computing system.

### BACKGROUND

Web-based computing systems including websites and web applications rely on third-party web services to add additional capabilities, site functionality, analytics, and other elements to enhance an end user experience. A third-party service running on a target website or web application can collect data on other services running on the target website. In addition, these third-party services can call other services to run on the target website, or send data to other services (also known as fourth-party services). In addition, these fourth-party services can further add other services (e.g., fifth-party services), which can add another layer of services (e.g., sixth-party services) and so on.

However, the ability for a third-party service to initiate the execution of a fourth-party service results in a lack of visibility into the connection between a website and associated third-party services. In addition, the target website further fails to have a complete understanding of the connections, communications, and dependencies between the third-party services and additionally spawned fourth-party services.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 depicts an illustrative system architecture, in accordance with one or more implementations of the present disclosure.

FIG. 2 depicts a process flow including aspects of an example method to generate a log including information identifying one or more web services of a target web asset, in accordance with one or more implementations of the present disclosure.

FIG. 3 depicts a process flow including aspects of an example method to generate a log including information identifying one or more web services of a target web asset using an override function, in accordance with one or more implementations of the present disclosure.

FIG. 4 depicts a process flow including aspects of an example method to generate a log including information identifying one or more web services embedded in code a target web asset, in accordance with one or more implementations of the present disclosure.

FIG. 5 depicts a block diagram of an illustrative computer system operating in accordance with aspects and implementations of the present disclosure.

### DETAILED DESCRIPTION

Aspects and implementations of the present disclosure address the above-identified problems by collecting data relating to web services executing on a web asset (e.g., a webpage, a web application, etc.) of a website (also referred to as a “target website”). In an embodiment, a system (herein a “web service relationship management system”) and method identify dependencies (e.g., connections) between code (e.g., a native code set) of the target website and one or more third-party web services.

In an embodiment, the system and method further detects dependencies between the one or more third-party web services and one or more other web services (e.g., a fourth-party web service, fifth-party web service, and so on). In addition, the system and method determines a relationship between the multiple web services. In an embodiment, the relationship can indicate which web service is an initiator web service (e.g., the web service that initiated the connection with the other web service and brought the other web service in to the executable code of the target website). In an embodiment, the relationship can identify the one or more web services that were added by the initiator web service as one or more target web services.

According to embodiments of the present disclosure, the web service relationship management system can identify and log an initiator web services and the one or more target web services which have a dependent relationship. Advantageously, the web service relationship management system enables a target website to identify and manage (e.g., delete, block, record, review, etc.) the collection of web services executing on the target website, including all target web services that are added by another web service (e.g., an initiator web service).

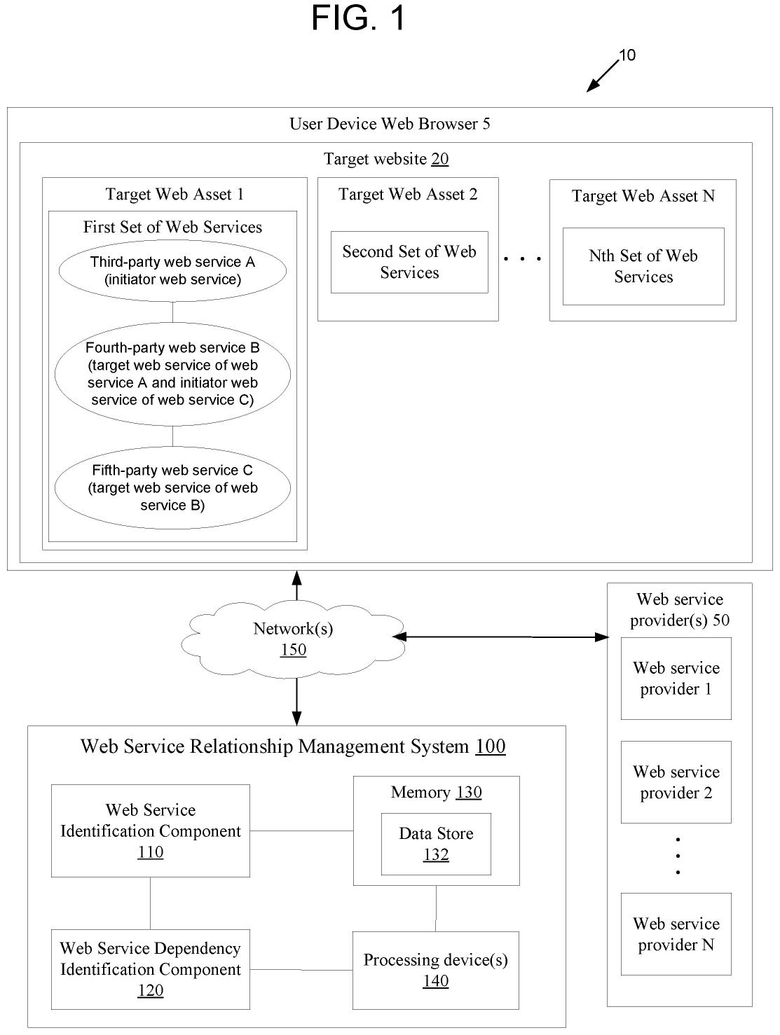

FIG. 1 depicts an illustrative computing environment 10, in accordance with one or more embodiments of the present disclosure. The computing environment 10 includes a web service relationship management system 100 configured to execute code across multiple target web assets (e.g., Target Web Asset 1, Target Web Asset 2 . . . Target Web Asset N) of a target website 20 to collect data relating to one or more web services (e.g., a first set of web services running on Target Web Asset 1, a second set of web services running on Target Web Asset 2, and a Nth set of web services running on Target Web Asset N). the executing on the respective web assets of the target website 20. provide adaptive code (e.g., adaptive code 50A, 50B . . . 50N) to a set of user device 20 including user device 22A, 22B . . . 22N). In an embodiment, the web service relationship management system 100 can be communicatively connected to the target website 20 executing via a web browser of a user device (e.g., user device web browser 5) via on or more networks 150. Example networks 150 can include a public, private, wired, wireless, hybrid network, or a combination of different types of networks. The network 1530 may be implemented as a local area network (“LAN”), a wide area network (“WAN”) such as the Internet, a corporate intranet, a metropolitan area network (“MAN”), a storage area network (“SAN”), a Fibre Channel (“FC”) network, a wireless cellular network (e.g., a cellular data network), or a combination thereof. According to embodiments, the user device web browser 5 can be any suitable web browser type, including, for example, Microsoft® Internet Explorer, Apple® Safari, Google® Chrome, etc.

In an embodiment, the web service relationship management system 100 includes one or more components configured to execute the functions, methods, operations, and processes described in detail herein. In an embodiment, the web service relationship management system 100 includes a web service identification component 110, a web service dependency identification component 120, a memory 130, and one or more processing devices 140. In another embodiment, one or more portions or components of the web service relationship management system 100 including one or more of the web service identification component 110 and the web service dependency identification component 120 can be installed (e.g., via a plug-in or other interface to the user device web browser 5) on and executed by the user device executing the web browser 5 (e.g., wherein the processing device(s) 140 are one or more processing devices of the user device). The user device can include any suitable computing system such as a personal computer (e.g., a desktop computer, laptop computer, server, a tablet computer), a workstation, a handheld device, a web-enabled appliance, a gaming device, a mobile phone (e.g., a Smartphone), an eBook reader, a camera, a watch, an in-vehicle computer/system, or any computing device enabled with one or more web browser 5.

Various applications or sets of code (e.g., a native code set associated with the target website 20 to enable the target web assets and code associated with the web service relationship management system 100) may run or execute on the user device (e.g., on the operating system (OS) of the user device). In certain implementations, the user device can also include and/or incorporate various sensors and/or communications interfaces (not shown). Examples of such sensors include but are not limited to: accelerometer, gyroscope, compass, GPS, haptic sensors (e.g., touchscreen, buttons, etc.), microphone, camera, etc. Examples of such communication interfaces include but are not limited to cellular (e.g., 3G, 4G, etc.) interface(s), Bluetooth interface, WiFi interface, USB interface, NFC interface, etc.

In an embodiment, the user device web browser 5 is configured to access the target website 20 which is configured to employ one or more web services provided by one or more web service providers 50. In an embodiment, a target asset (e.g., a webpage, a web application, etc.) is configured to execute a third-party web service which can initiate one or more additional web services (e.g., a fourth-party web service). In an embodiment, a third-party web service that initiates another web service is referred to as an initiator web service. In an embodiment, the other web service that is initiated by a third-party web service is referred to as a target web service. It is noted that a web service can be both an initiator web service and a target web service.

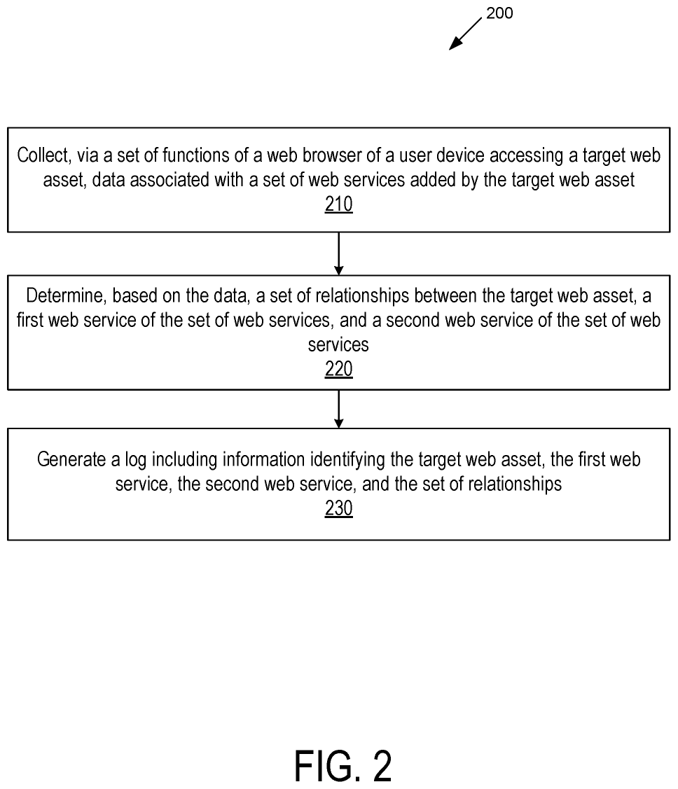

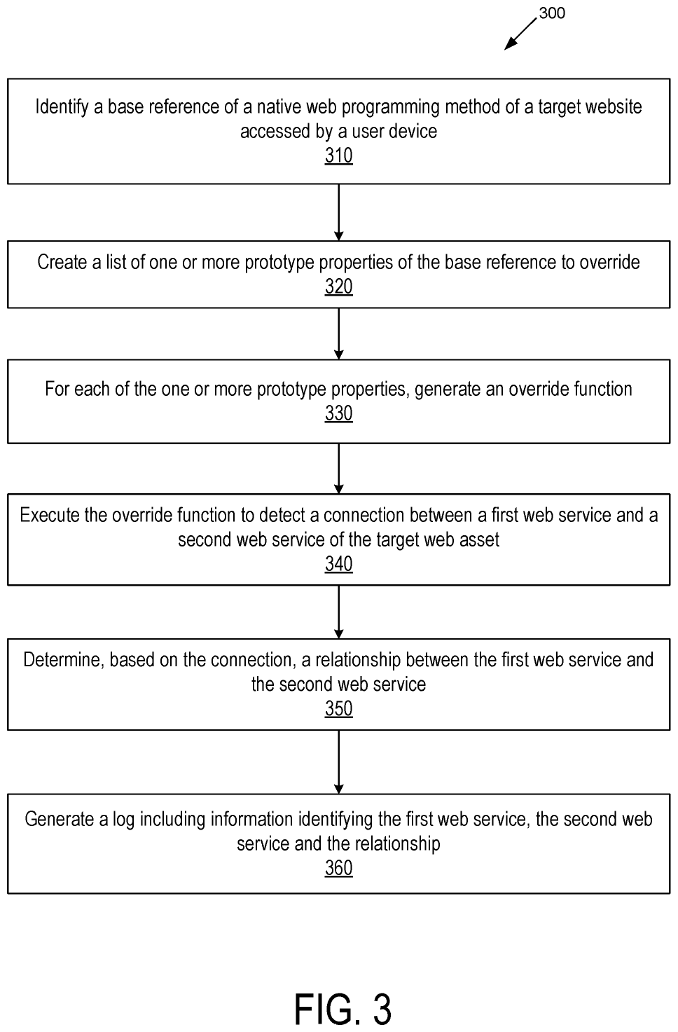

In an embodiment, the web service identification component 110 identifies a set of web services (e.g., third-party web service, fourth-party web service, Nth party web services) that are running on a respective target web asset of the target website 20. In an embodiment, the web service identification component 110 can identify and collect data associated with the set of web services that are dynamically added by a native code set of the target website 20 or by one or more tools of the target website 20, as described in greater detail with reference to FIGS. 2 and 3. In an embodiment, the web service identification component 110 collects the data associated with the web services (also referred to as the “web services data”) by accessing one or more application programming interfaces (APIs) of a web browser running the target website 20. In an embodiment, the web services identification component 110 collects the web services data by overriding one or more native web programming methods (e.g., JavaScript) of the target website 20 to add functionality to detect one or more communications between the target website 20 and a third-party web service and one or more communications between one or more third-party web services (e.g., an initiator web service) and one or more additional web services (e.g., target web services including fourth-party web services connected to a third-party web service, fifth-party web services connected to a fourth-party web service, and so on).

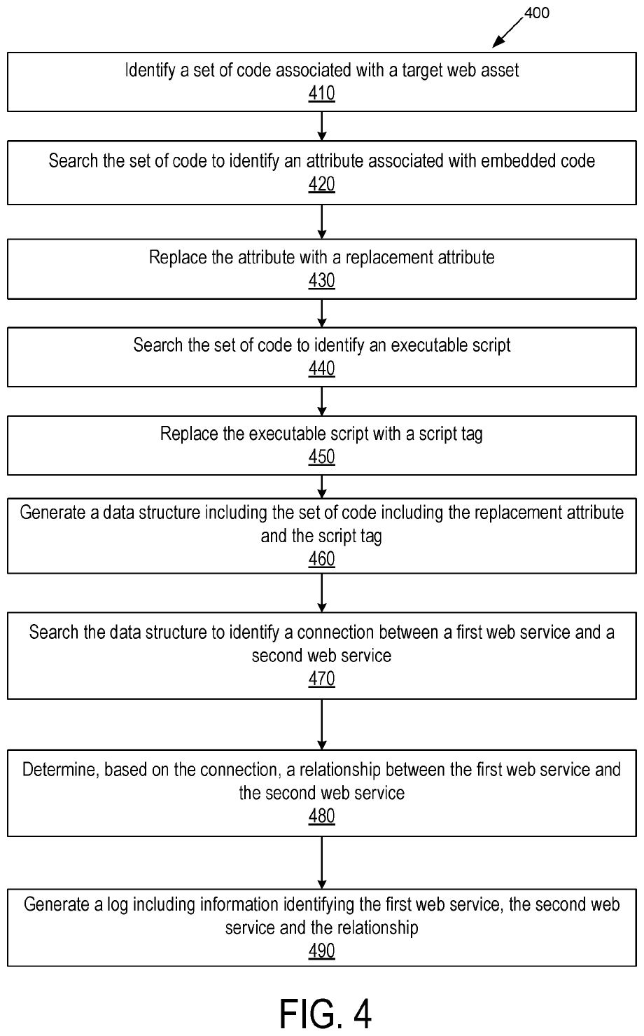

In an embodiment, the web service identification component 110 can identify and collect data associated with the set of web services that embedded within a native code set (e.g., a set of hypertext markup language (HTML) code associated with the generation of the target website 20), as described in greater detail with reference to FIG. 4.

In an embodiment, the web service identification component 110 provides the collected data associated with the web services to the web service dependency identification component 120. The web service dependency identification component 120 uses the collected data to determine a relationship (e.g., a dependency, connection, communication, etc.) between multiple web services running on a target asset of the target website 20 or during a session. browser with data on connection, dependencies, or communication between the target website 20 and one or more web services running on a page or during a session and between the multiple web services of the target website. In an embodiment, the web service dependency identification component 120 identifies a set of prototype properties to override and generates a function (e.g., a wrapper function) to each prototype property to be overwritten to detect relationships between the multiple web services of a target asset (e.g., a webpage or web application) of the target website 20.

In an example shown in FIG. 1, the web service relationship management system 100 can identify a first set of web services running on target web asset 1 of the target website 20 accessed by the user device web browser 5. In this example, the web service relationship management system 100 determines the first set of web services include web service A, web service B and web service C. The web service relationship management system 100 further determines the relationship between the first set of web services, particularly that web service A is a third-party web service associated with the native code of the target website A. Web service A is an initiator web service associated with web service B, which is a target web service. Web service B is identified as a fourth-party web service since it was initiated by the third-party web service A. In addition, the web service relationship management system 100 determines that web service B is an initiator web service relating to target web service C. Web service C is identified as a fifth-party web service since it was initiated by the fourth-party web service B. In this example, web service B is both a target web service in view of the relationship with web service A and an initiator web service (in view of the relationship with web service C.

In an embodiment, the web service relationship management system 100 is configured to perform various functions, operations, and activities relating to the management of web services, as described in greater detail with reference to FIGS. 2-4. In an embodiment, the web service relationship management system 100 can include one or more programs or components configured to perform the functions and operations described in detail herein, and can include a memory 130 including a data store 132 to store one or more sets of instructions or programs corresponding to the processes and methods of FIGS. 2-4 and corresponding logs or other data structures relating to the information identifying the web services and associated relationships. The web service relationship management system 100 also includes one or more processing devices 140 configured to execute the instructions stored in the memory 130 to implement the processes executed by the web service relationship management system 100, as described in greater detail herein.

FIG. 2 depicts a flow diagram of aspects of a method 200 for generating a log including information identifying web services that are dynamically loaded or added by a code set or one or more programming tools of a target web asset of a target website via a web browser accessing the target website, in accordance with embodiments of the present disclosure. The method is performed by processing logic that may comprise hardware (circuitry, dedicated logic, etc.), software, or a combination of both. In one implementation, the method is performed by one or more elements depicted and/or described in relation to FIG. 1 (including but not limited to the web service relationship management system 100), while in some other implementations, one or more blocks of FIG. 2 may be performed by another machine or machines.

For simplicity of explanation, methods are depicted and described as a series of operations. However, the operations in accordance with this disclosure can occur in various orders and/or concurrently, and with other operations not presented and described herein.

Furthermore, not all illustrated operations may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In operation 210, the processing logic collect, via a set of functions of a web browser of a user device accessing a target web asset, data associated with a set of web services added by the target web asset. In an embodiment, the set of web services include web services that were dynamically added by code of the target web asset (e.g., a webpage or web application) or one or more tools of the target web asset. In an embodiment, at least a portion of the set of web services are not part of the native code set of the target web asset, but instead are added later during execution of the target web asset. In an embodiment, one or more of web services of the set of web services may have been loaded or added by another web service (e.g., an initiator web service). In an embodiment, the data associated with each of the web services of the set of web services can include any information identifying the web service, including a web service name, a web service type, a web service size, one or more connections associated with the web service, one or more dependencies associated with the web service, one or more communications between the web services, operations and functions of the web service, a web service provider, etc. In an embodiment, the processing logic collects the data by accessing one or more sets of functions (e.g., APIs) of a web browser of a user device accessing the target web asset.

In operation 220, the processing logic determines, based on the data, a set of relationships between the target web asset, a first web service of the set of web services, and a second web service of the set of web services. In an embodiment, the set of relationships can identify a connection with the target web asset, one or more other web services, or both. In an embodiment, a first identified relationship of the set of relationships can indicate that the first web service is a target web service initiated and loaded by code of the target web asset. In an embodiment, a further identified relationship can indicate that the first web service is an initiator web service that initiated or launched the second web service. In this example, the second web service is a target web service that is dependent upon the first web service. Further, in this example, the first web service is considered a third-party web service and the second web service is considered a fourth-party web service.

In operation 230, the processing logic generates a log including information identifying the target web asset, the first web service, the second web service, and the set of relationships. In an embodiment, the log can be any suitable data structure (e.g., a table) that is stored in data store. In an embodiment, one or more outputs (e.g., a graphical user interface, a report, etc.) can be generated using the log and data included therein.

FIG. 3 depicts a flow diagram of aspects of a method 300 for generating a log including information identifying web services that are dynamically loaded or added by a code set or one or more programming tools (e.g., a testing tool, extension tools, API management tools, etc.) of a target web asset of a target website using an override function, in accordance with embodiments of the present disclosure. The method is performed by processing logic that may comprise hardware (circuitry, dedicated logic, etc.), software, or a combination of both. In one implementation, the method is performed by one or more elements depicted and/or described in relation to FIG. 1 (including but not limited to the web service relationship management system 100), while in some other implementations, one or more blocks of FIG. 3 may be performed by another machine or machines. In an embodiment, the method 300 can be performed in one or more instances when data associated with the web services cannot be obtained via a web browser (as described in method 200). In this embodiment, the processing logic can override the native web programming methods (e.g., JavaScript) to detect and add the functionality of logging any communication between the target website and a third-party service, as well as any communication or data shared between third-party and fourth-party services, and fourth-party to fifth-party services, and so on.

For simplicity of explanation, methods are depicted and described as a series of operations. However, the operations in accordance with this disclosure can occur in various orders and/or concurrently, and with other operations not presented and described herein. Furthermore, not all illustrated operations may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In operation 310, the processing logic identifies a base reference of a native web programming method of a target web asset accessed by a user device. In an embodiment, the base reference of the native web programming method (e.g., JavaScript) can include one or more methods or actions to be performed on one or more objects of the target asset of a target website. Example methods of the base reference can include fetch, write, writeIn, appendChild, insertBefore, insertAdj acentElement, innerHTML, insertAdj acentHTML, setAttribute, open, src attribute (set method), send Beacon, etc. Example objects of the base reference can include windowObj, docProto, elProto, xhrProto, scriptProto, iframeProto, imgProto, navigatorProto, etc.

In operation 320, the processing logic creates a list of one or more prototype properties of the base reference to override. In an embodiment, the base reference (e.g., set of native code) is analyzed to identify one or more prototype properties that can cause an action (e.g., a call to an external system such as a web service). In an embodiment, the processing logic can maintain a list of prototype properties that are to be overridden and uses the list to examine the base reference.

In operation 330, for each of the one or more prototype properties, the processing logic generates an override function. In an embodiment, the override function (e.g., a wrapper function) adds additional logic or code to an original set of code (e.g., a wrapper function) of the base reference. In an embodiment, the override function includes logic (e.g., a markAccess function) configured to perform one or more operations including detecting a relationship, connection, or dependency between web services, identifying each web service as an initiator web service, a target web service, or both, and logging the relationship, connection or dependencies between all of the identified web services.

In operation 340, the processing logic executes the override function to detect a connection between a first web service and a second web service associated with the target web asset.

In an example, the processing logic saves one or more parameters received from the override function to detect a target domain. In an embodiment, the processing logic obtains a stack trace (e.g., by executing a function such as a getStackTrace function) in the context of the overridden function (e.g., by creating a general “error” instance, in a controlled manner, and retrieving a stack of a web browser as a string through the general error instance). In an embodiment, the processing logic splits the stack trace string into one or more rows. In this embodiment, each row represents a function call and includes an associated universal resource locator (URL) path.

In operation 350, the processing logic determines, based on the connection, a relationship between the first web service and the second web service. In an embodiment, a last row can be associated with an initiator call and include a URL associated with an initiator service. In an embodiment, the processing logic fetches a first domain from the URL associated with the initiator service (e.g., an initiator service domain). For example, the first web service can be identified in this manner as the initiator web service. In an embodiment, the processing logic fetches a domain from the one or more parameters received from the overridden function and identifies a second domain associated with a target web service (e.g., a target web service domain). For example, the second web service can be identified in this manner as the target web service. Accordingly, the initiator-target relationship between the first web service and the second web service is determined for this identified connection.

In operation 360, the processing logic generates a log (e.g., a data structure including one or more records associated with the detected web services) including information identifying the first web service, the second web service, and the relationship. In an embodiment, the processing logic logs one or more domain pairs, where each domain pair includes information identifying an initiator web service domain (e.g., the first web service) and a target web service domain (e.g., the second web service). It is noted that a web service domain can be identified as an initiator web services having one or more target web services, a target web service, or both. In an embodiment, the processing logic replaces the original web function with the override function.

Advantageously, execution of method 300 enables the processing logic to detect multiple types of web service relationships including code of the target web asset that either initiates (e.g., brings in) or sends data to one or more third-party web services dynamically and third-party web services that initiates (e.g., brings in) or sends data to one or more additional web services (e.g., fourth-party services) using the override process of method 300.

FIG. 4 depicts a flow diagram of aspects of a method 400 for generating a log including information identifying web services that are embedded within a set of code (e.g., HTML code) of a target web asset, in accordance with embodiments of the present disclosure. The method is performed by processing logic that may comprise hardware (circuitry, dedicated logic, etc.), software, or a combination of both. In one implementation, the method is performed by one or more elements depicted and/or described in relation to FIG. 1 (including but not limited to the web service relationship management system 100), while in some other implementations, one or more blocks of FIG. 3 may be performed by another machine or machines.

For simplicity of explanation, methods are depicted and described as a series of operations. However, the operations in accordance with this disclosure can occur in various orders and/or concurrently, and with other operations not presented and described herein. Furthermore, not all illustrated operations may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

In operation 410, the processing logic identifies a set of code associated with a target web asset. In an embodiment, the set of code can include the HTML code used to generate one or more aspects of the target web asset (e.g., web page or web application). In an embodiment, the processing logic calls the code set of the target web asset to enable analysis of embedded code for the detection of dependencies between the target web asset and one or more third-party web. In an embodiment, the processing logic can initiate a network request (e.g., a AJAX/XMLHttpRequest) to obtain the content of the target web asset and retrieve the original code set of the target web asset (e.g., the target web asset's HTML content as text).

In an embodiment, when the target web asset is fetched, it is done in an isolated or sandboxed manner in order to prevent the target web asset from being reloaded with the native logic and services. Accordingly, in this embodiment, the embedded third-party web services on the target web asset are not be executed when the target web asset is fetched. Advantageously, this ensures the execution of method 400 does not burden the performance of the target web asset or the end user experience.

In operation 420, the processing logic searches the set of code to identify an attribute associated with embedded code. In an embodiment, the processing logic searches inside the HTML text using a command (e.g., a regex command) to identify one or more attributes including the first attribute. In an embodiment, the first attribute can be an src attribute (e.g., an attribute specifying a URL of an image), a HyperText Reference (href) attribute (e.g., an attribute used to create a link to another web page), and/or a data attribute (e.g., an attribute used to store custom data associated with the target web asset).

In operation 430, the processing logic replaces the attribute with a replacement attribute. In an embodiment, the processing logic replaces the attribute with a different property name (e.g., “nmgscr”) to prevent execution in runtime.

In operation 440, the processing logic searches the set of code to identify an executable script. In an embodiment, the executable script can include an inline script that does not include an src attribute.

In operation 450, the processing logic replaces the executable script with a script tag. In an embodiment, the script tag is an empty script tag (e.g., “<script></script>”) which is used too prevent execution of the inline script at runtime.

In operation 460, the processing logic generates a data structure including the set of code including the replacement attribute and the script tag. In an embodiment, the data structure includes an in-memory DOM tree structure associated with the retrieved target web asset that is created by generating an HTML element. In an embodiment, the set of code associated with the target web asset has been cleaned (via the replacements in operation 430 and 450) such that elements that can initiate a network call and executable inline scripts have been removed. In an embodiment, the set of code can be parsed safely without side effects to the data structure (e.g. the HTML DOM tree), by adding the set of code to the created data structure.

In operation 470, the processing logic searches the data structure to identify a connection between a first web service and a second web service. In an embodiment, the DOM tree is searched to identify one or more elements (e.g., an element such as “iframe/script/img/link/embed/object/video/audio/source”) relating to web services. In an embodiment, the processing logic extracts one or more web service domains from the retrieved elements.

In an embodiment, the processing logic identifies one or more embedded web services that call other web service services by analyzing the executable script (e.g., the inline script including a piece of code) that is embedded on the target web asset. In an embodiment, the raw HTML text is cleaned from the executable inline scripts, and the web service performs a regex search for third-party valid URL patterns, inside the detected inline scripts. In an embodiment, the processing logic extracts the domains from the fetched URLs on the target web asset.

In operation 480, the processing logic determines, a relationship between the first web service and the second web service. In an embodiment, the processing log identifies domain pairs including an initiator web service and a target web service. For example, the first web service can be identified in this manner as the initiator web service. In an embodiment, the processing logic fetches a domain from the one or more parameters received from the overridden function and identifies a second domain associated with a target web service (e.g., a target web service domain). For example, the second web service can be identified in this manner as the target web service. Accordingly, the initiator-target relationship between the first web service and the second web service is determined for this identified connection.

In an embodiment, domains can be extracted from the one or more URLs fetched as a result of a search within the detected executable inline scripts.

In operation 490, the processing logic generates a log (e.g., a data structure including one or more records associated with the detected web services) including information identifying the first web service, the second web service, and the relationship. In an embodiment, the processing logic logs one or more domain pairs, where each domain pair includes information identifying an initiator web service domain (e.g., the first web service) and a target web service domain (e.g., the second web service). It is noted that a web service domain can be identified as an initiator web services having one or more target web services, a target web service, or both. In an embodiment, the processing logic logs the domain pairs (e.g., a pair including a site\page domain (i.e., the initiator web service) and an inline embedded web service domain (i.e., the target web service)). Once logged, these dependencies are stored in a data store with records with information including, for example, each call made between each web service, the relationship between the web services (e.g., the nature of the dependency (i.e., whether a web service is calling it to the target web asset or sending data), the target web asset (e.g., webpage) that the activity occurred on, a time of the occurrence, and data about the end user.

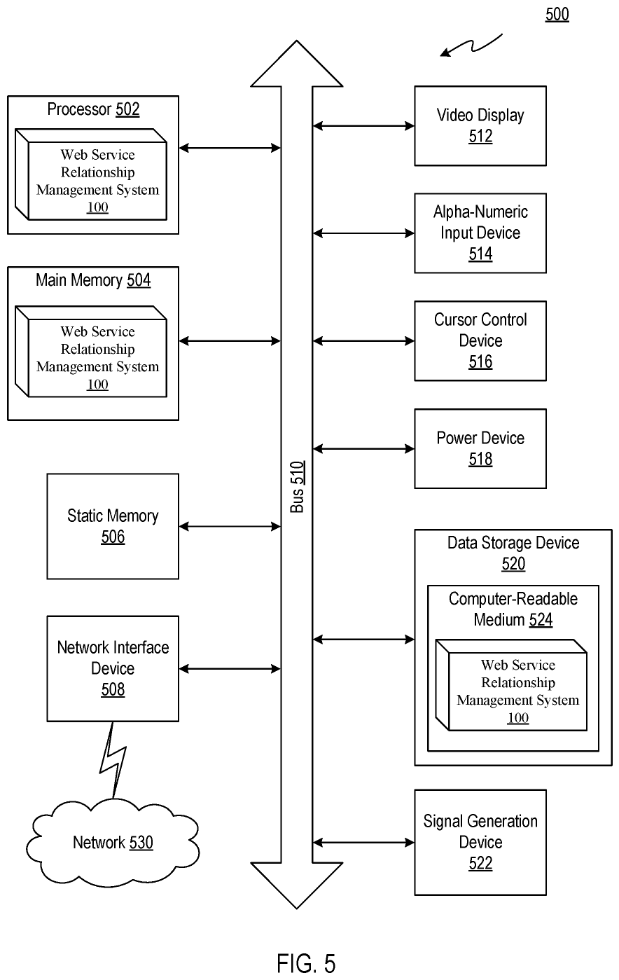

FIG. 5 depicts an illustrative computer system within which a set of instructions, for causing the machine to perform any one or more of the methodologies discussed herein, may be executed. In alternative implementations, the machine may be connected (e.g., networked) to other machines in a LAN, an intranet, an extranet, or the Internet. The machine may operate in the capacity of a server machine in client-server network environment. The machine may be a computing device integrated within and/or in communication with a vehicle, a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 500 includes a processing system (processor) 502, a main memory 504 (e.g., read-only memory (ROM), flash memory, dynamic random access memory (DRAM) such as synchronous DRAM (SDRAM)), a static memory 506 (e.g., flash memory, static random access memory (SRAM)), and a data storage device 516, which communicate with each other via a bus 508.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 502 may also be one or more special-purpose processing devices such as an application specific integrated circuit (ASIC), a field programmable gate array (FPGA), a digital signal processor (DSP), network processor, or the like. The processor 502 is configured to execute instructions of an adaptive code generation system 100 for performing the operations discussed herein.

The computer system 500 may further include a network interface device 522. The computer system 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and a signal generation device 520 (e.g., a speaker).

The data storage device 516 may include a computer-readable medium 524 on which is stored one or more sets of instructions (e.g., instructions executed by the adaptive code generation system 100) embodying any one or more of the methodologies or functions described herein. The instructions of the adaptive code generation system 100 may also reside, completely or at least partially, within the main memory 504 and/or within the processor 502 during execution thereof by the computer system 500, the main memory 504 and the processor 502 also constituting computer-readable media. The instructions of the adaptive code generation system 100 may further be transmitted or received over a network via the network interface device 522.

While the computer-readable storage medium 524 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “processing,” “comparing,” “identifying,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Aspects and implementations of the disclosure also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform certain operations. In addition, the present disclosure is not described with reference to any particular programming language. It will be appreciated that a variety of programming languages may be used to implement the teachings of the disclosure as described herein.

It is to be understood that the above description is intended to be illustrative, and not restrictive. Many other embodiments will be apparent to those of skill in the art upon reading and understanding the above description. Moreover, the techniques described above could be applied to practically any type of data. The scope of the disclosure should, therefore, be determined with reference to the appended claims, along with the full scope of equivalents to which such claims are entitled.

What is claimed is:

1. A method comprising:
collecting, via a set of functions of a web browser of a user device accessing a target web asset, data associated with a set of web services added by the target web asset;
determining, based on the data, a set of relationships between the target web asset, a first web service of the set of web services, and a second web service of the set of web services; and
generating a log including information identifying the target web asset, the first web service, the second web service, and the set of relationships.

2. The method of claim 1, wherein the first web service is added to the target web asset by code of the target web asset or one or more tools of a website comprising the target web asset.

3. The method of claim 1, wherein the set of relationships comprises a first relationship indicating the first web service is a first target web service added by the target web asset.

4. The method of claim 3, wherein the set of relationships comprises a second relationship indicating that the second web service is a second target web service added by the first web service.

5. The method of claim 1, wherein the data comprises information identifying one or more communications between the first web service and the second web service.

6. A system comprising:
a memory to store instructions; and
a processing device, operatively coupled to the memory, the processing device to execute the instructions to perform operations comprising:
identifying a base reference of a native web programming method of a target website accessed by a user device;
creating a list of one or more prototype properties of the base reference to override;
for each of the one or more prototype properties, generating an override function;
executing the override function to detect a connection between a first web service and a second web service of the target web asset;
determining, based on the connection, a relationship between the first web service and the second web service; and
generating a log including information identifying the first web service, the second web service and the relationship.

7. The system of claim 6, wherein the native web programming method comprises one or more JavaScript methods.

8. The system of claim 6, wherein the override function comprises a code set added to a native code set of the native web programming method.

9. The system of claim 6, wherein the connection comprises information identifying one or more communications between the first web service and the second web service.

10. The system of claim 6, the operations further comprising:
storing one or more parameters received from execution of the override function; and
detecting, based on the one or more parameters, a domain pair comprising a first domain associated with the first web service and a second domain associated with the second web service.

11. The system of claim 10, wherein the first domain indicates the first web service is an initiator web service that loaded the second domain associated with the second web service.

12. The system of claim 6, wherein one or more functions of the native programming method are replaced by the override function.

13. The system of claim 6, the operations further comprising: identifying a portion of the native programming method that performs one or more of loading the first web service or sending data to the first web service.

14. The system of claim 8, wherein the resource availability function comprises a measurement of a network strength of the first user device based on a duration of time to send a request from the first user device to a remote system and receive a return transmission from the remote system.

15. A non-transitory computer readable medium comprising instructions that, if executed by a processing device, cause the processing device to perform operations comprising:
identifying a set of code associated with a target web asset;
searching the set of code to identify an attribute associated with embedded code;
replacing the attribute with a replacement attribute;
generating a data structure including the set of code including the replacement attribute;
searching the data structure to identify a connection between a first web service and a second web service;
determining, based on the connection, a relationship between the first web service and the second web service; and
generating a log including information identifying the first web service, the second web service and the relationship.

16. The non-transitory computer readable medium of claim 15, the operations further comprising searching the set of code to identify an executable script.

17. The non-transitory computer readable medium of claim 16, the operations further comprising replacing the executable script with a script tag.

18. The non-transitory computer readable medium of claim 17, wherein the data structure further comprises the script tag.

19. The non-transitory computer readable medium of claim 15, wherein the first web service is embedded the set of code of the target web asset.

20. The non-transitory computer readable medium of claim 15, wherein the connection comprises information identifying one or more communications between the first web service and the second web service, and wherein the first web service loads the second web service on the target web asset.
